(19) United States
(12) Patent Application Publication
(10) Pub. No.: US 2026/0217174 A1
(43) Pub. Date: Jul. 30, 2026

(54) ARMREST ASSEMBLY, VEHICLE, AND METHOD FOR OPENING THE ARMREST ASSEMBLY

(71) Applicant: FAURECIA AUTOMOTIVE INTERIOR SYSTEM (SHANGHAI) CO., LTD., Shanghai (CN)

(72) Inventor: JUNJIE TANG, Shanghai (CN)

(21) Appl. No.: 19/409,635

(22) Filed: Dec. 4, 2025

(30) Foreign Application Priority Data
Dec. 4, 2024 (CN) 202411776645.4

(51) Int. Cl. B60N 2/75; B60R 7/04; E05B 83/32

(52) U.S. Cl. CPC B60N 2/793; B60R 7/04; E05B 83/32

(57) ABSTRACT

The present disclosure provides an armrest assembly, a vehicle, and a method for opening the armrest assembly. And the armrest assembly includes a housing, providing a storage space; a cover, being arranged corresponding to an opening of the storage space, and the cover being connected to the housing via a first rotating mechanism and a second rotating mechanism, and the first rotating mechanism and the second rotating mechanism being connected to a front part and a rear part of the cover in a first direction, and the first rotating mechanism and the second rotating mechanism being able to be disengaged from the cover; and the cover being able to rotate around a first rotating axis via the first rotating mechanism, and to rotate around a second rotating axis via the second rotating mechanism.

### CROSS-REFERENCE TO RELATED APPLICATION

This application claims priority of Chinese Patent Application No. 202411776645.4, filed on December 4, 2024, the contents of which are entirely incorporated herein by reference.

### FIELD

The present disclosure relates to an armrest assembly, a vehicle, and a method for opening the armrest assembly.

### BACKGROUND

Armrest assemblies, such as center console armrests of vehicle interiors, are provided with armrest boxes having a storage function for storing small items such as beverages and cups, allowing users to easily access these items when needed. Armrest boxes can also be referred to as armrest compartments, central armrest storage boxes, storage containers, etc.

Due to the storage space provided by the center console armrest, some items are usually stored therein. However, common center console armrests are generally convenient for front-row users, such as those in the driver's seat and front passenger's seat, but are difficult for rear-row passengers to open.

In addition, in some rotary-opening armrest assemblies, the cover rotates backward after being opened, making it difficult for rear-row passengers to take and place items in the storage space.

### SUMMARY

The present disclosure provides an armrest assembly.

The present disclosure provides a vehicle.

The present disclosure provides a method for opening the armrest assembly.

The present disclosure provides an armrest assembly according to embodiments of the disclosure. The armrest assembly includes a housing, providing a storage space; and a cover, being arranged corresponding to an opening of the storage space, and the cover being connected to the housing via a first rotating mechanism and a second rotating mechanism, and the first rotating mechanism and the second rotating mechanism being connected to a front part and a rear part of the cover in a first direction, and the first rotating mechanism and the second rotating mechanism being able to be disengaged from the cover; and the cover being able to rotate around a first rotating axis via the first rotating mechanism, and to rotate around a second rotating axis via the second rotating mechanism, and the first rotating axis is parallel to the second rotating axis, and extension directions of the first rotation axis and the second rotation axis are both in a second direction, and the first direction and the second direction are perpendicular to each other; and the armrest assembly has a first state or a second state: when the armrest assembly is in the first state, the cover is disengaged from the first rotation mechanism, and the cover is able to be rotated to a first open position through the second rotation mechanism to open the storage space; when the armrest assembly is in the second state, the cover is disengaged from the second rotation mechanism, and the cover is able to be rotated to a second open position through the first rotation mechanism to open the storage space.

In some embodiments of the present disclosure, the first rotation mechanism and/or the second rotation mechanism include a first base, and the first base is fixedly connected to a first rotating shaft, and the first base is able to rotate around the first rotating axis or the second rotating axis; and the armrest assembly further includes a first locking mechanism, and the first base and the cover are detachably connected via the first locking mechanism located on the cover, and the first locking mechanism includes a first operating member, a rotating disk, and a locking tongue, and the locking tongue is able to be limited by a connection hole of the first base, and the first operating member can receive an operating force and move, driving the rotating disk to rotate, and driving the locking tongue connected to the rotating disk to move along the connection hole to disconnect the first base and the cover, and the first rotating mechanism and the second rotating mechanism is able to be disengaged from the cover.

In some embodiments of the present disclosure, the first operating member includes a first operating portion and a rack, and the rotating disk includes a gear portion located on one side of the rotating disk and an arc-shaped slide groove portion located on the other side of the rotating disk, and the locking tongue includes a first matching portion and a second matching portion, and the first matching portion is set to match the connecting hole, and the second matching portion is set to match the arc-shaped slide groove portion via a slide fit.

In some embodiments of the present disclosure, the base has a plurality of connection holes, and the first locking mechanism has a corresponding plurality of locking tongues, and the rotating disk has a plurality of arc-shaped sliding grooves, and the plurality of connection holes, the plurality of locking tongues and the plurality of arc-shaped sliding grooves are symmetrically arranged.

In some embodiments of the present disclosure, the first rotating mechanism and/or the second rotating mechanism include a second base fixed to the housing, and the second base is provided with a shaft mounting hole; and the armrest assembly further includes a second locking mechanism, and the second base is detachably connected to the cover through the second locking mechanism located on the cover; and the second locking mechanism includes a second operating member, a second transmission assembly, and a second rotating shaft; the second rotating shaft member can cooperate with the rotating shaft mounting hole, and the cover is able to rotate around the first rotating axis or the second rotating axis; and the second operating member is able to receive a rotating operating torque, and the second transmission member is able to convert the rotating torque output by the second operating member into movement, driving the second rotating shaft to move along the second direction to disengage from the rotating shaft mounting hole, and the first rotating mechanism and the second rotating mechanism can be disengaged from the cover.

In some embodiments of the present disclosure, the second transmission member is accommodated a chamber of the second operating member, and the second transmission member includes a moving member and an elastic member; and the second operating member has a slider portion, and an outer wall of the moving member has a guiding groove, and the guiding groove cooperates with the slider portion, making a rotation of the second operating member drives the moving member to move along the second direction, and a free end of the elastic member is connected to the moving member.

In some embodiments of the present disclosure, two second bases are arranged on both sides of the housing in the second direction, and each second locking mechanism is arranged corresponding to each second base.

In addition, the present disclosure provides a vehicle according to embodiments of the disclosure, and the vehicle includes the armrest assembly as described in the above embodiments.

In some embodiments of the present disclosure, the armrest assembly includes a center console armrest of a vehicle interior.

In addition, the present disclosure provides a method for opening an armrest assembly according to embodiments of the disclosure. The method is employed for the armrest assembly as described in the above embodiments, and the method includes followings steps: a front row passenger of the vehicle operating at front part of the armrest in the first direction to disengage the first rotating mechanism from the cover, and the cover being rotated to the first open position through the second rotating mechanism to open the storage space; and a rear row passenger of the vehicle operating the rear part of the armrest in the first direction to disengage the second rotating mechanism from the cover, and the cover being rotated to the second open position through the first rotating mechanism to open the storage space.

### DESCRIPTION OF ATTACHED DRAWINGS

The above and other embodiments of the present disclosure will become more apparent through the following description in conjunction with the accompanying drawings and embodiments, and:

FIG. 1 is a schematic structural diagram of a vehicle and an armrest assembly according to an embodiment;

FIGS. 2A and 2B are schematic structural diagrams of the armrest assembly when the cover is closed according to an embodiment;

FIG. 3 is a schematic structural diagram of the armrest assembly when the cover is disengaged from the first rotating mechanism according to an embodiment;

FIG. 4 is a schematic structural diagram of the armrest assembly when the cover is disengaged from the second rotating mechanism according to an embodiment;

FIG. 5 is a schematic assembly structure diagram of a first base and a first

locking mechanism of the armrest assembly according to an embodiment;

FIG. 6 is a schematic exploded structure diagram of the first base and the first locking mechanism of the armrest assembly according to an embodiment;

FIG. 7 is a schematic assembly structure diagram of a second base and a second locking mechanism of the armrest assembly according to an embodiment;

FIG. 8 is a schematic diagram of the cooperation between a second operating member and a moving member of the armrest assembly according to an embodiment;

FIG. 9 is a schematic flow diagram of a method for opening the armrest assembly according to an embodiment.

### REFERENCE NUMERALS

1000 – Vehicle

1001 - Center console armrest

100 - Armrest assembly

101 - First state

102 - Second state

1 – Housing

11 - Storage space

110 - Opening of the storage space

2 – Cover

201 - First open position

202 - Second open position

31 - First rotating mechanism

32 - Second rotating mechanism

401 - First rotating axis

402 - Second rotating axis

51 - First base

511 - Connection hole

52 - Second base

521 - Shaft mounting hole

61 - First locking mechanism

611 - First operating member

6111 - First operating portion

6112 – Rack

612 - Rotating disk

6121 - Gear portion

6122 - Arc-shaped slide groove portion

613 - Locking tongue

6131 - First matching portion

6132 - Second matching portion

62 - Second locking mechanism

621 - Second operating member

6210 – Chamber

6211 - Slider portion

622 - Second transmission member

6221 - Moving member

6222 - Elastic member

6223 - Guiding groove

623 - Second rotating shaft

71 - First rotating shaft.

### DETAILED DESCRIPTION OF EMBODIMENTS

Hereinafter, embodiments of the present disclosure will be described in detail with reference to the drawings. And embodiments are merely used to more clearly explain the embodiments of the present disclosure, and therefore are merely examples, and should not limit the scope of protection of the present disclosure.

Unless otherwise defined, all technical and scientific terms used herein have the same meaning as commonly understood in the art of the present disclosure. The terms used herein are for the purpose of describing embodiments only and not intended to limit the present disclosure; The terms "including" and "having" and any variations thereof in the specification and claims of the present disclosure and the above description of drawings are intended to cover non-exclusive inclusions.

In the embodiments of the present disclosure, the technical terms "first", "second" and the like are only used to distinguish different objects, and should not be understood to indicate or imply relative importance or implicitly indicate the number, specific order, or primary-secondary relationship of the indicated features. In the embodiments of the present disclosure, "a plurality" means two or more unless otherwise explicitly and specifically defined.

An "embodiment" means that a particular feature, structure, or characteristic described may be included in at least one embodiment of the present disclosure. The appearance of the word "embodiment" in various places in the specification does not necessarily refer to the same embodiment, nor refer to an independent or alternative embodiment that is mutually exclusive from other embodiments. It may be explicitly and implicitly understood in the art that the embodiments described herein may be combined with other embodiments.

In the embodiments of the present disclosure, the technical terms such as "center", " longitude", " latitude", "length", "width", "thickness", "upper", "lower", "front", "rear", "left", "right", "vertical", "horizontal", "top", "bottom", "inner", "outer", "clockwise", "counterclockwise", "axial", "radial", "circumferential" and the like are based on the orientation or positional relationships shown in the drawings, and are merely used to facilitate and simplify the description of the embodiments of the present disclosure, and do not indicate or imply that the referred device or element must have a specific orientation, be constructed and operated in a specific orientation, and therefore cannot be understood as a limitation of the embodiments of the present disclosure.

In the embodiments of the present disclosure, unless otherwise explicitly specified and defined, technical terms such as "mounted", "linked", "connected" and "fixed" should be understood in a broad sense, for example, they may be fixed connected, detachable connected, or integrated; It may also be a mechanical connection, and tit can understand that the specific meanings of the above terms in the embodiments of the present disclosure according to specific circumstances.

It can be understood that flowcharts are used in the present disclosure to illustrate operations performed by the system according to embodiments of the present disclosure. It should be understood that, depending on the actual situation, the preceding or following operations are not necessarily performed precisely in order. One can also add additional steps to these procedures, or remove a step or steps from them.

Although the armrest assembly disclosed in the embodiments of the present disclosure is applicable to automobiles, it is not limited thereto. For example, it can be applied to other kinds of vehicles such as railway trains, ships, aircraft, etc., as long as the effect that both front-row and rear-row users of the armrest assembly can conveniently and quickly open the storage space provided by the armrest assembly is achieved, the armrest assembly, vehicle, and method for opening the armrest assembly disclosed in the embodiments can be applied.

In the following description, the first direction and the second direction are shown as X direction and Y direction in the figures, but are not limited thereto.

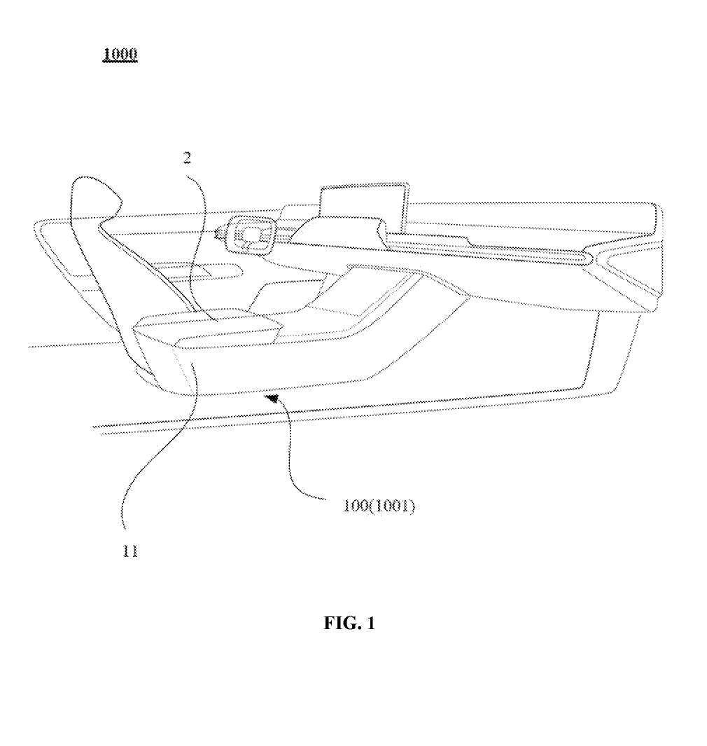

Referring to FIG. 1, an automobile is taken as an example of a vehicle 1000. The armrest assembly 100 can be a center console armrest 1001 arranged in the cockpit of the vehicle. The storage space 11 of the center console armrest 1001 is normally opened or closed by the cover 2. In the embodiments described below, the structure of the armrest assembly 100 will be described in detail. It can be understood that the seats of the vehicle 1000 are normally arranged in multiple rows, that is, the one shown in FIG. 1 is a driver's seat in the front row, and the vehicle normally further includes rear seats of a rear row behind the front row.

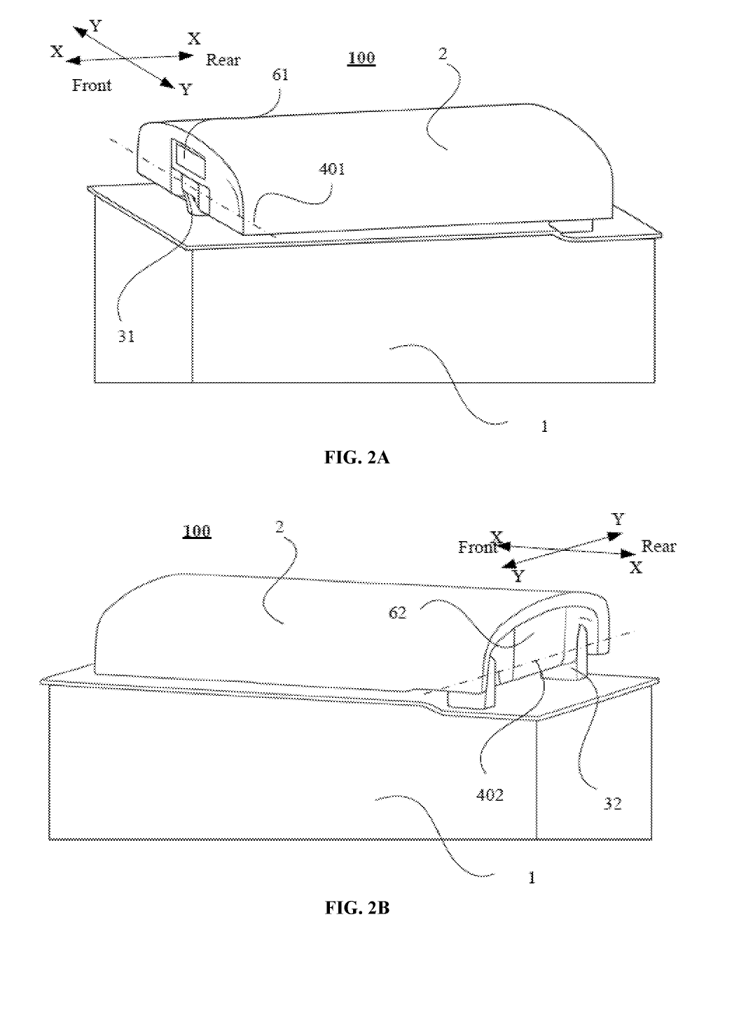

As shown in FIGS. 2A, 2B to 4, in some embodiments, the armrest assembly 100 includes: a housing 1, a cover 2, a first rotating mechanism 31, and a second rotating mechanism 32.

The housing 1 provides a storage space 11.

The cover 2 is arranged corresponding to the opening 110 of the storage space, and the cover 2 is connected to the housing 1 via a movement mechanism 3, and the cover 2 is able to move relative to the housing 1 to open or close the storage space 11.

The cover 2 is connected to the housing 1 via the first rotating mechanism 31 and the second rotating mechanism 32. The first rotating mechanism 31 and the second rotating mechanism 32 are respectively connected to a front part and a rear part of the cover 2 in a first direction, and the first rotating mechanism 31 and the second rotating mechanism 32 are able to be disengaged from the cover 2. The cover 2 is able to rotate around a first rotating axis 401 via the first rotating mechanism 31 and around a second rotating axis 402 via the second rotating mechanism 32. The first rotating axis 401 is parallel to the second rotating axis 402, the extending directions of both the first rotating axis 401 and the second rotating axis 402 are a second direction, and the first direction and the second direction are perpendicular to each other.

The armrest assembly 100 has a first state 101 or a second state 102.

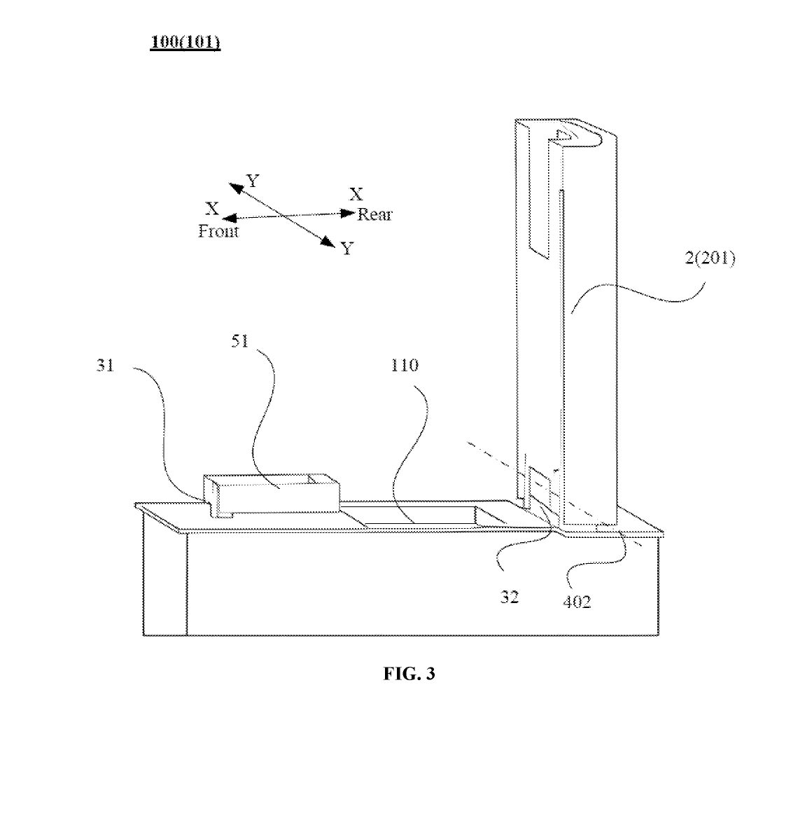

As shown in FIG. 3, when the armrest assembly 100 is in the first state 101, the cover 2 is disengaged from the first rotating mechanism 31, and the cover 2 is able to be rotated to the first open position 201 via the second rotating mechanism 32 to open the storage space 11.

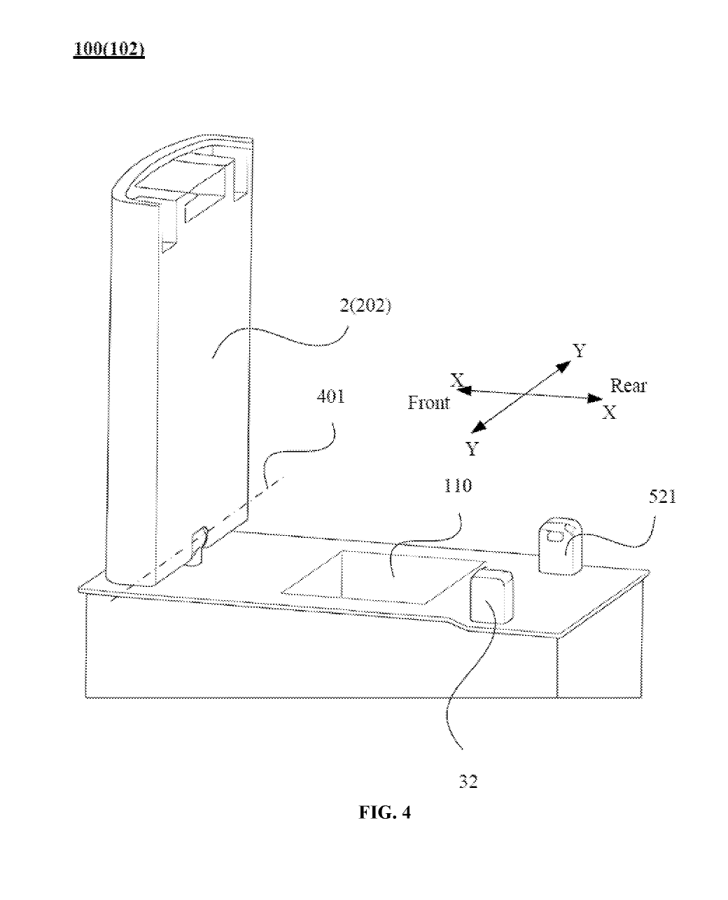

As shown in FIG. 4, when the armrest assembly 100 is in the second state 102, the cover 2 is disengaged from the second rotating mechanism 31, and the cover 2 is able to be rotated to the second open position 202 via the first rotating mechanism 31 to open the storage space 11.

The beneficial effect of the above embodiment is that, by means of a structure in which the cover is connected to the housing via the first rotating mechanism and the second rotating mechanism, the first rotating mechanism and the second rotating mechanism are respectively connected to the front part and the rear part of the cover in the first direction, and the first rotating mechanism and the second rotating mechanism are able to be disengaged from the cover, both front-row and rear-row users of the armrest assembly are able to conveniently and quickly open the storage space provided by the armrest assembly, thereby improving user experience.

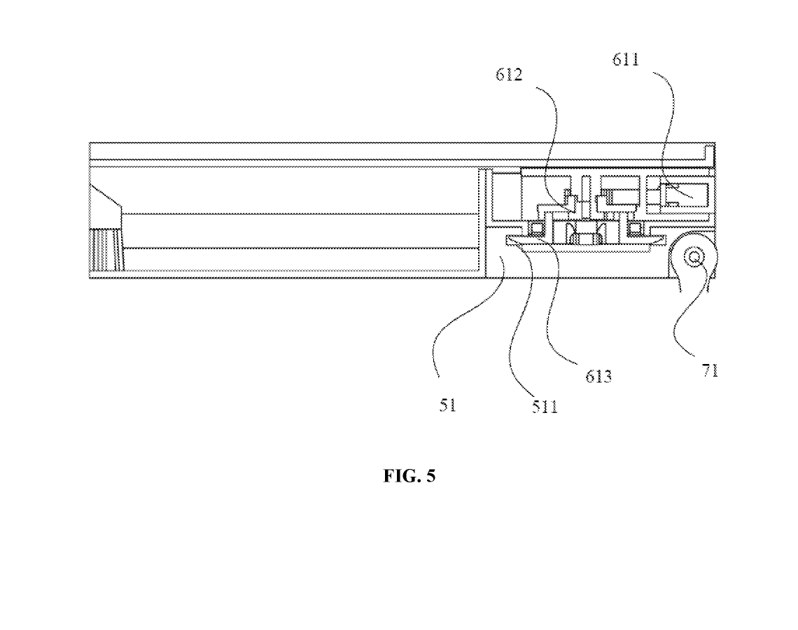

Referring to FIGS. 5 to 8, in some embodiments, the first rotating mechanism 31 and/or the second rotating mechanism 32 include a first base 51, and the first base 51 is fixedly connected to the first rotating shaft 71 so the first base 51 is able to rotate around the first rotating axis 401 or the second rotating axis 402.

In some embodiments, the first rotating mechanism 31 and/or the second rotating mechanism 32 include a second base 52 fixed to the housing 1, and the second base 52 is provided with a shaft mounting hole 521 to the first base 51 is able to rotate around the first rotating axis 401 or the second rotating axis 402.

It can be understood that, in the embodiments shown in FIGS. 2A, 2B to 8, arrangement of positions of the first base 51 and the second base 52 is that the first rotating mechanism 31 includes the first base 51 and the second rotating mechanism 32 includes the second base 52 as shown in the figures, or both the first rotating mechanism 31 and the second rotating mechanism 32 include the first base 51 but not the second base 52, or both the first rotating mechanism 31 and the second rotating mechanism 32 include the second base 52 but not the first base 51, which are not limited thereto. In the embodiment shown in the figures, the first rotating mechanism 31 includes the first base 51, and the second rotating mechanism 32 includes the second base 52 and corresponding structures, which further facilitates front-row and rear-row passengers to open the cover 2 to take and place items in the storage space 11.

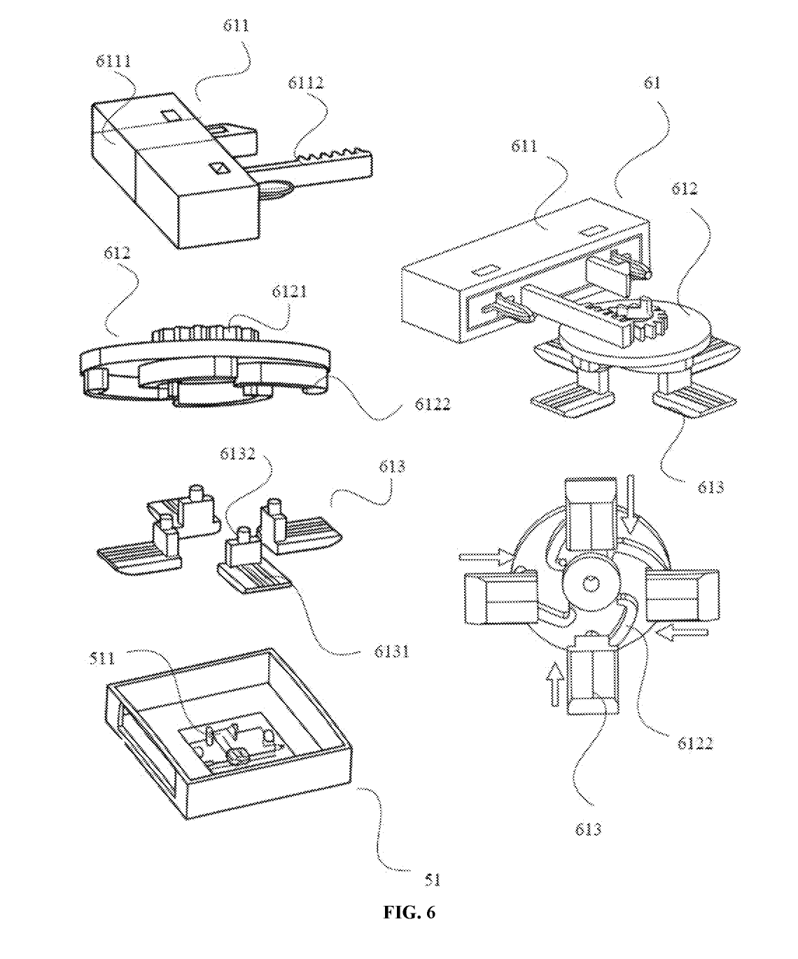

Continuing to refer to FIGS. 5 and 6, in some embodiments, the armrest assembly 100 further includes a first locking mechanism 61. The first base 51 is detachably connected to the cover 2 via the first locking mechanism 61 located on the cover 2. The first locking mechanism 61 includes a first operating member 611, a rotating disk 612, and a locking tongue 613. The locking tongue 613 is able to be blocked by cooperation with the connection hole 511 of the first base 51. The first operating member 611 is able to receive an operating force and move to drive the rotating disk 612 to rotate, and the locking tongue 613 connected to the rotating disk 612 moves along the connection hole 511 to release the connection between the first base 51 and the cover 2, enabling the first rotating mechanism 31 and the second rotating mechanism 32 to be disengaged from the cover 2. The advantage of the locking mechanism with such a structure is that it is simple and compact, and easy to unlock and lock, further facilitating the user to open the cover.

Continuing to refer to FIGS. 5 and 6, the structure of the first locking mechanism 61 is that the first operating member 611 includes a first operating portion 6111 and a rack 6112, the rotating disk 612 includes a gear portion 6121 located on one side of the rotating disk and an arc-shaped slide groove portion 6122 located on the other side of the rotating disk, the locking tongue 613 includes a first matching portion 6131 and a second matching portion 6132, the first matching portion 6131 is able to cooperate with the connection hole 511, and the second matching portion 6132 is able to be fitted with the arc-shaped slide groove portion 6122 by a slide fit. The structure with a gear on one side and an arc-shaped slide groove on the other side is compact and easy for the user to operate. The user only needs to apply a pressing force to the first operating portion 6111 to operate it.

Continuing to refer to FIGS. 5 and 6, in some embodiments, the structure of the first locking mechanism 61 is that the base 51 has a plurality of connection holes 511, the first locking mechanism 61 has a corresponding plurality of locking tongues 613, and the rotating disk 612 has a plurality of arc-shaped slide groove portions 6122, and the plurality of connection holes 511, the plurality of locking tongues 613, and the plurality of arc-shaped slide groove portions 6122 are symmetrically arranged. The beneficial effect of this is that the locking structure is relatively stable, which enables the cover to be firmly connected to the first rotating mechanism 31 or the second rotating mechanism 32, and is also easy to disassemble and assemble.

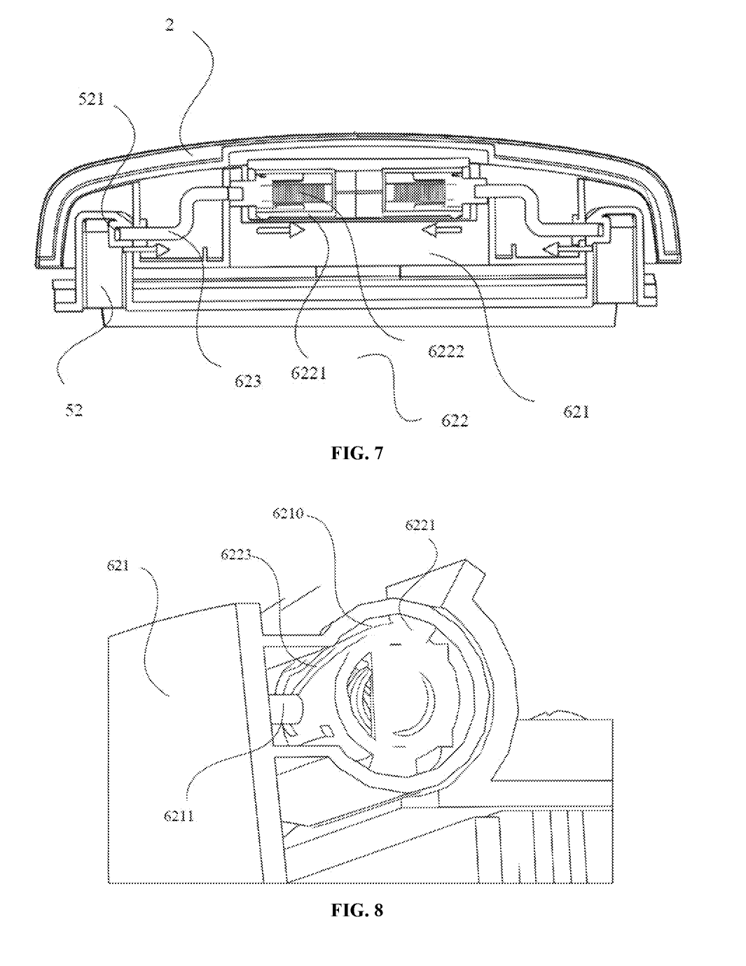

Referring to FIGS. 7 to 8, the armrest assembly 100 further includes a second locking mechanism 62. The second base 52 is detachably connected to the cover 2 via the second locking mechanism 62 located on the cover 2.

The second locking mechanism 62 includes a second operating member 621, a second transmission member 622, and a second rotating shaft 623. The second rotating shaft 623 is able to cooperate with the shaft mounting hole 521 so the cover 2 is able to rotate around the first rotating axis 401 or the second rotating axis 402.

The second operating member 621 is able to receive a rotating operating torque, and the second transmission member 622 is able to convert the rotating torque output by the second operating member 621 into movement to drive the second rotating shaft 623 to move along the second direction to disengage from the shaft mounting hole 521, enabling the first rotating mechanism 31 and the second rotating mechanism 32 to be disengaged from the cover 2.

Continuing to refer to FIGS. 7 to 8, in some embodiments, the structure in which the second transmission member 622 is able to convert the rotating torque output by the second operating member 621 into movement to drive the second rotating shaft 623 is that the second transmission member 622 is accommodated inside the chamber 6210 of the second operating member 621, and the second transmission member 622 includes a moving member 6221 and an elastic member 6222. The second operating member 621 has a slider portion 6211, an outer wall of the moving member 6221 has a guiding groove 6223, the guiding groove 6223 cooperates with the slider portion 6211 so rotation of the second operating member 621 drives the moving member 6221 to move along the second direction, and a free end of the elastic member 6222 is connected to the moving member 6221. When the operating torque is released, the elastic force of the elastic member 6222 is released to drive the moving member 6221 to return. However, it is not limited thereto. For example, an ordinary worm gear structure that converts rotation into movement can also be used, but the structure shown in the figures adopts a reciprocating movement principle similar to that of a mechanical pencil. Using the second rotating shaft 623 as a component of the second locking mechanism to provide locking and unlocking functions, and also providing a rotating shaft function, makes the overall structure more compact.

Continuing to refer to FIGS. 7 to 8, in some embodiments, two second bases 52 are disposed on both sides of the housing 1 in the second direction, and each second locking mechanism 62 is disposed corresponding to each second base 52. The beneficial effect of this is that the structure is compact and easy to disassemble and assemble.

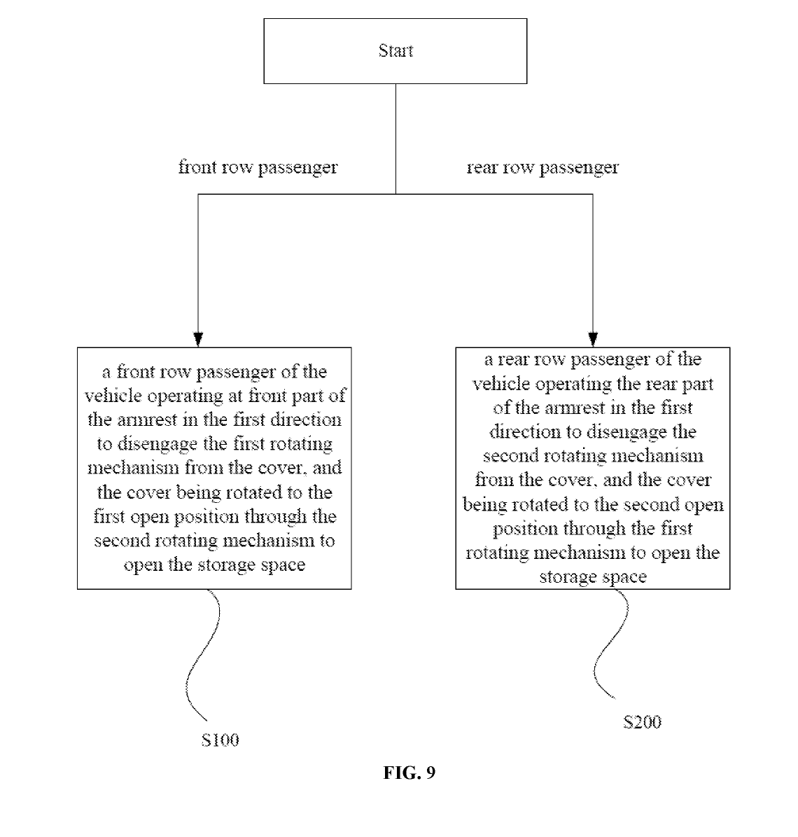

As described above, referring to FIG. 9, the present disclosure further provides a method for opening an armrest assembly, which employs the armrest assembly 100 as described in the above embodiments, and the method includes the following steps.

S100. A front-row passenger of the vehicle operates a front part of the armrest assembly 100 in the first direction to disengage the first rotating mechanism 31 from the cover 2, and the cover 2 is rotated to the first open position 201 via the second rotating mechanism 32 to open the storage space 11.

S200. A rear-row passenger of the vehicle operates a rear part of the armrest assembly 100 in the first direction to disengage the second rotating mechanism 32 from the cover 2, and the cover 2 can be rotated to the second open position 202 via the first rotating mechanism 31 to open the storage space 11.

In summary, the beneficial effects of the armrest assembly, vehicle, and method for opening the armrest assembly as described in the above embodiments include but are not limited to: by means of the structure in which the cover is connected to the housing via the first rotating mechanism and the second rotating mechanism, the first rotating mechanism and the second rotating mechanism are respectively connected to the front part and the rear part of the cover in the first direction, and the first rotating mechanism and the second rotating mechanism can be disengaged from the cover, both front-row and rear-row users of the armrest assembly can conveniently and quickly open the storage space provided by the armrest assembly, thereby improving user experience.

Although the present disclosure is disclosed as above with embodiments, it is not intended to limit the present disclosure. Possible changes and modifications may be made without departing from the spirit and scope of the present disclosure. Therefore, any modification, equivalent change, and modification made to the above embodiments according to the essence of the present disclosure without departing from the content of the embodiments of the present disclosure shall fall within the scope defined by the claims of the present disclosure.

What is claimed is:

1. An armrest assembly for vehicle interior, comprising:
a housing, providing a storage space; and
a cover, being arranged corresponding to an opening of the storage space, and the cover being connected to the housing via a first rotating mechanism and a second rotating mechanism, and the first rotating mechanism and the second rotating mechanism being connected to a front part and a rear part of the cover in a first direction, and the first rotating mechanism and the second rotating mechanism being able to be disengaged from the cover; and the cover being able to rotate around a first rotating axis via the first rotating mechanism, and to rotate around a second rotating axis via the second rotating mechanism, and the first rotating axis is parallel to the second rotating axis, and extension directions of the first rotation axis and the second rotation axis are both in a second direction, and the first direction and the second direction are perpendicular to each other;
wherein the armrest assembly has a first state or a second state:
when the armrest assembly is in the first state, the cover is disengaged from the first rotation mechanism, and the cover is able to be rotated to a first open position through the second rotation mechanism to open the storage space; and
when the armrest assembly is in the second state, the cover is disengaged from the second rotation mechanism, and the cover is able to be rotated to a second open position through the first rotation mechanism to open the storage space.

2. The armrest assembly according to claim 1, wherein the first rotation mechanism and/or the second rotation mechanism include a first base, and the first base is fixedly connected to a first rotating shaft, and the first base is able to rotate around the first rotating axis or the second rotating axis; and
the armrest assembly further includes a first locking mechanism, and the first base and the cover are detachably connected via the first locking mechanism located on the cover, and the first locking mechanism includes a first operating member, a rotating disk, and a locking tongue, and the locking tongue is able to be limited by a connection hole of the first base, and the first operating member can receive an operating force and move, driving the rotating disk to rotate, and driving the locking tongue connected to the rotating disk to move along the connection hole to disconnect the first base and the cover, and the first rotating mechanism and the second rotating mechanism is able to be disengaged from the cover.

3. The armrest assembly according to claim 2, wherein the first operating member comprises a first operating portion and a rack, and the rotating disk comprises a gear portion located on one side of the rotating disk and an arc-shaped slide groove portion located on the other side of the rotating disk, and the locking tongue comprises a first matching portion and a second matching portion, and the first matching portion is set to match the connecting hole, and the second matching portion is set to match the arc-shaped slide groove portion via a slide fit.

4. The armrest assembly according to claim 3, wherein the base has a plurality of connection holes, and the first locking mechanism has a corresponding plurality of locking tongues, and the rotating disk has a plurality of arc-shaped sliding grooves, and the plurality of connection holes, the plurality of locking tongues and the plurality of arc-shaped sliding grooves are symmetrically arranged.

5. The armrest assembly according to claim 1, wherein the first rotating mechanism and/or the second rotating mechanism include a second base fixed to the housing, and the second base is provided with a shaft mounting hole;
wherein the armrest assembly further includes a second locking mechanism, and the second base is detachably connected to the cover through the second locking mechanism located on the cover;
wherein the second locking mechanism includes a second operating member, a second transmission assembly, and a second rotating shaft; the second rotating shaft member can cooperate with a rotating shaft mounting hole, and the cover is able to rotate around the first rotating axis or the second rotating axis; and
the second operating member is able to receive a rotating operating torque, and the second transmission member is able to convert the rotating torque output by the second operating member into movement, driving the second rotating shaft to move along the second direction to disengage from the rotating shaft mounting hole, and the first rotating mechanism and the second rotating mechanism can be disengaged from the cover.

6. The armrest assembly according to claim 5, wherein the second transmission member is accommodated a chamber of the second operating member, and the second transmission member comprises a moving member and an elastic member; and the second operating member has a slider portion, and an outer wall of the moving member has a guiding groove, and the guiding groove cooperates with the slider portion, making a rotation of the second operating member drives the moving member to move along the second direction, and a free end of the elastic member is connected to the moving member.

7. The armrest assembly according to claim 5, wherein two second bases are arranged on both sides of the housing in the second direction, and each second locking mechanism is arranged corresponding to each second base.

8. A vehicle, comprising an armrest assembly for vehicle interior, comprising:
a housing, providing a storage space; and
a cover, being arranged corresponding to an opening of the storage space, and the cover being connected to the housing via a first rotating mechanism and a second rotating mechanism, and the first rotating mechanism and the second rotating mechanism being connected to a front part and a rear part of the cover in a first direction, and the first rotating mechanism and the second rotating mechanism being able to be disengaged from the cover; and the cover being able to rotate around a first rotating axis via the first rotating mechanism, and to rotate around a second rotating axis via the second rotating mechanism, and the first rotating axis is parallel to the second rotating axis, and extension directions of the first rotation axis and the second rotation axis are both in a second direction, and the first direction and the second direction are perpendicular to each other;
wherein the armrest assembly has a first state or a second state:
when the armrest assembly is in the first state, the cover is disengaged from the first rotation mechanism, and the cover is able to be rotated to a first open position through the second rotation mechanism to open the storage space;
when the armrest assembly is in the second state, the cover is disengaged from the second rotation mechanism, and the cover is able to be rotated to a second open position through the first rotation mechanism to open the storage space.

9. The vehicle according to claim 8, wherein the armrest assembly includes a center console armrest of a vehicle interior.

10. The vehicle according to claim 8, wherein the first rotation mechanism and/or the second rotation mechanism include a first base, and the first base is fixedly connected to a first rotating shaft, and the first base is able to rotate around the first rotating axis or the second rotating axis; and
the armrest assembly further includes a first locking mechanism, and the first base and the cover are detachably connected via the first locking mechanism located on the cover, and the first locking mechanism includes a first operating member, a rotating disk, and a locking tongue, and the locking tongue is able to be limited by a connection hole of the first base, and the first operating member can receive an operating force and move, driving the rotating disk to rotate, and driving the locking tongue connected to the rotating disk to move along the connection hole to disconnect the first base and the cover, and the first rotating mechanism and the second rotating mechanism is able to be disengaged from the cover.

11. The vehicle according to claim 8, wherein the first rotating mechanism and/or the second rotating mechanism include a second base fixed to the housing, and the second base is provided with a shaft mounting hole;
wherein the armrest assembly further includes a second locking mechanism, and the second base is detachably connected to the cover through the second locking mechanism located on the cover;
wherein the second locking mechanism includes a second operating member, a second transmission assembly, and a second rotating shaft; the second rotating shaft member can cooperate with a rotating shaft mounting hole, and the cover is able to rotate around the first rotating axis or the second rotating axis; and the second operating member is able to receive a rotating operating torque, and the second transmission member is able to convert the rotating torque output by the second operating member into movement, driving the second rotating shaft to move along the second direction to disengage from the rotating shaft mounting hole, and the first rotating mechanism and the second rotating mechanism can be disengaged from the cover.

12. A method for opening an armrest assembly, being employed for an armrest assembly of a vehicle, and the armrest assembly comprising:
a housing, providing a storage space; and
a cover, being arranged corresponding to an opening of the storage space, and the cover being connected to the housing via a first rotating mechanism and a second rotating mechanism, and the first rotating mechanism and the second rotating mechanism being connected to a front part and a rear part of the cover in a first direction, and the first rotating mechanism and the second rotating mechanism being able to be disengaged from the cover; and the cover being able to rotate around a first rotating axis via the first rotating mechanism, and to rotate around a second rotating axis via the second rotating mechanism, and the first rotating axis is parallel to the second rotating axis , and extension directions of the first rotation axis and the second rotation axis are both in a second direction, and the first direction and the second direction are perpendicular to each other;
wherein the armrest assembly has a first state or a second state:
when the armrest assembly is in the first state, the cover is disengaged from the first rotation mechanism, and the cover is able to be rotated to a first open position through the second rotation mechanism to open the storage space;
when the armrest assembly is in the second state, the cover is disengaged from the second rotation mechanism, and the cover is able to be rotated to a second open position through the first rotation mechanism to open the storage space;
and the method comprises following steps:
a front row passenger of the vehicle operating at front part of the armrest in the first direction to disengage the first rotating mechanism from the cover, and the cover being rotated to the first open position through the second rotating mechanism to open the storage space; and
a rear row passenger of the vehicle operating the rear part of the armrest in the first direction to disengage the second rotating mechanism from the cover, and the cover being rotated to the second open position through the first rotating mechanism to open the storage space.

13. The method according to claim 12, wherein the first rotation mechanism and/or the second rotation mechanism include a first base, and the first base is fixedly connected to a first rotating shaft, and the first base is able to rotate around the first rotating axis or the second rotating axis;
and the armrest assembly further includes a first locking mechanism, and the first base and the cover are detachably connected via the first locking mechanism located on the cover, and the first locking mechanism includes a first operating member, a rotating disk, and a locking tongue, and the locking tongue is able to be limited by a connection hole of the first base, and the first operating member can receive an operating force and move, driving the rotating disk to rotate, and driving the locking tongue connected to the rotating disk to move along the connection hole to disconnect the first base and the cover, and the first rotating mechanism and the second rotating mechanism is able to be disengaged from the cover.

14. The method according to claim 12, wherein the first rotating mechanism and/or the second rotating mechanism include a second base fixed to the housing, and the second base is provided with a shaft mounting hole;
wherein the armrest assembly further includes a second locking mechanism, and the second base is detachably connected to the cover through the second locking mechanism located on the cover; and
wherein the second locking mechanism includes a second operating member, a second transmission assembly, and a second rotating shaft; the second rotating shaft member can cooperate with the rotating shaft mounting hole, and the cover is able to rotate around the first rotating axis or the second rotating axis; and the second operating member is able to receive a rotating operating torque, and the second transmission member is able to convert the rotating torque output by the second operating member into movement, driving the second rotating shaft to move along the second direction to disengage from the rotating shaft mounting hole, and the first rotating mechanism and the second rotating mechanism can be disengaged from the cover.
